(19) United States
(12) Patent Application Publication
(10) Pub. No.: US 2013/0337961 A1
(43) Pub. Date: Dec. 19, 2013

(54) DUAL CLUTCH GEARBOX

(71) Applicant: Johannes Kaltenbach, Friedrichshafen (DE)

(72) Inventor: Johannes Kaltenbach, Friedrichshafen (DE)

(73) Assignee: ZF Friedrichshafen AG, Friedrichshafen (DE)

(21) Appl. No.: 13/985,612

(22) PCT Filed: Feb. 1, 2012
(86) PCT No.: PCT/EP2012/051613

§ 371 Date: Aug. 15, 2013

(30) Foreign Application Priority Data
Mar. 3, 2011 (DE) 102011005028.0

(51) Int. Cl. F16H 37/04

(52) U.S. Cl. CPC F16H 37/046
USPC 475/207; 74/331

(57) ABSTRACT

A double clutch transmission with two clutches (K1, K2) is proposed in which each clutch inputs is connected with a drive shaft (w0) and the clutch outputs are respectively coupled with two, coaxial positioned transmission input shaft (w1, w2) of partial transmissions. The double clutch transmission comprises two counter shafts (w3, w6), coaxial positioned with respect to one another. Each partial transmission has several, shiftable gear ratio steps assigned thereto which each can be coupled with the output shaft (w5), via the assigned counter shaft (w3, w6) and via a main shaft (w4) which is linked to an input section of a planetary transmission which is designed as range group, The output shaft (w5) is positioned coaxially with respect to the driveshaft (w0). At least one shiftable gear ratio step, of at least one of the partial transmissions, can be coupled with the output shaft (w5) independent from the range group.

This application is a National Stage completion of PCT/EP2012/051613 filed Feb. 1, 2012, which claims priority from German patent application serial no. 10 2011 005 028.0 filed Mar. 3, 2011.

### FIELD OF THE INVENTION

The present invention concerns a double clutch gearbox.

### BACKGROUND OF THE INVENTION

For instance, a load shiftable group transmission with a double clutch, in which the driveshaft and the output shaft are coaxially positioned to each other, is known through the publication DE 10 2005 044 068 A1. Two transmission input shafts, which are both designed as the partial transmissions, meshing with one another through input constants with one of the counter shafts, whereby the counter shafts are positioned coaxial to one another. Also, the known transmission comprises of a main shaft which can be coupled to shift a direct gear with use one of the transmission input shafts. The output end side of the main shaft is connected with a sun gear which represents the input element of a range group which is designed as a planetary transmission. The planetary gear carrier is torque proof connected with a transmission output shaft or output shaft, respectively. Thus, all gear steps are transferred to the output shaft, via the range group. Therefore, at least the gear step, in which a range shift takes place, cannot be designed as load shiftable.

Also known via DE 198 50 549 A1 publication is a double clutch transmission for a motor vehicle in which an input shaft of the transmission is coupled with an electric machine so that a starter and a generator can be waived for the combustion engine.

### SUMMARY OF THE INVENTION

The present invention has the task of proposing a double clutch transmission, of the above mentioned genus, with possibly many load shiftable gear steps and possibly fewest wheel planes and shift elements.

Thus, a double clutch gearbox with two clutches is proposed which, on one hand, are connected with the driveshaft and, on the other hand, with the assigned transmission input shafts for both partial transmissions. In each case, a counter shaft is assigned to both partial transmissions so that several, shiftable gear ratios steps or wheel planes, respectively, can be created which can be coupled via the respective counter shaft and via the main shaft of a planetary transmission, designed as a range group, with an assigned output shaft to transfer the selected gear ratio to the output. The output shaft, of the double clutch transmission, is hereby coaxially positioned with the driveshaft. It is now provided, in accordance with the invention, that at least one shiftable gear ratio step is not realized via the range group. It means that at least a gear ratio or gear step, respectively, of at least one of the partial transmissions is transferred to the output shaft, independent of the range group which is designed as planetary gear set.

Hereby an independent power path, independent from the range shifting, is provided for the output so that all forward gears can be sequentially and load shiftable executed. Therefore, the advantages of a range group, in the proposed double clutch transmission, and the advantages of independent power paths can be combined with one another so that a wheel set is created which has less components due to the dual-use of gear ratios steps or wheel planes, respectively, and which constructively creates, in a simple way, a maximum number of load shiftable gears.

It is another advantage that by a main shaft of the clutch transmission, positioned coaxially with the driveshaft and output shaft, at least one more advantageous direct gear can be realized which is a step better in the efficiency. For instance, as a sixth or also as an eighth forward gear. But also other configuration variations are possible for the direct gear.

Within the framework of a possible embodiment variation of the invention it can be provided that the used shift elements, in the invented double clutch transmission, for the shifting of the gear ratios steps are designed to the counter shafts of the partial transmissions and to the main shaft of the transmission, whereby the transmission input shafts of the partial transmissions are each connected, via a drive constant, as a spur gear with the design counter shaft. Applied as shift elements can be double-acting shift elements or double-shift elements, respectively which, dependent on the shift direction, either connect one or the other assigned idle gears of the wheel plane with the assigned shaft. It is possible that a dual-side acting shift element can be replaced by two single acting shift elements, or vice versa. For instance, hydraulically, electrically, pneumatically, and mechanically activated clutches or also form-fitting claw clutches can be applicable as shift elements, as well as any kind of synchronizations which serve as a torque proof connection between an idle gear and a shaft.

The provided range group or the planetary transmission, respectively, can for instance be shifted by one or several shift elements whereby, for instance, a ring gear of the planetary transmission can be connected, via the shift element, with the housing or with a planetary carrier. Hereby, the gear ratios steps which are assigned to the wheel planes, can be coupled with the output shaft, via the intermediate shafts or counter shafts, respectively, and via the main shaft which is connected with the planetary carrier so that, dependent on the shift direction of the assigned shift elements, the number of the gears can be double via the planetary transmission, whereby four gears are provided for each partial transmission. The range group gear ratio can be selected with a large increase so that the gear sequence can be accordingly expanded.

Also, the selected power path, independent of the range group, can be coupled via a wheel plane of the second partial transmission or the second counter shaft, respectively, directly with the output shaft and independent from the main shaft, whereby the respective wheel plane is directly attached to the planetary carrier. This gear ratio step can be, for instance, assigned as the fifth gear so that the range group can be shifted, before a change into the sixth gear. By this method, at least the first eight forward gears can be executed sequentially and load shiftable.

Thus, nine forward gears and two reverse gears can be preferably realized with this invented double clutch transmission, with just seven gear ratios steps or wheel planes, respectively, which are assigned to both partial transmissions. Preferably, the shiftable gear ratios steps can be designed as spur gear ratio steps. Six of the wheel planes, which are designed to the partial transmissions, are coupled via the main shaft and the planetary transmission with the output shaft, whereby the seventh gear ratio step or wheel plane, respectively, is independent of the range group or main shaft, respectively, directly coupled with the output shaft.

It can be provided, independent of the respective embodiment variation of the double clutch transmission, that at least an electric machine is provided for the realization of a hybrid concept. The electric machine can be, for instance, coupled at the partial transmissions and/or also in the area of the main shaft with the wheel set. For the connection of the electric machine with a partial transmission, it can be coupled directly or also via a shiftable connection with the assigned transmission input shaft.

If the electric machine, in the hybrid concept, is assigned to the main shaft, it can be attached at the side, for instance, via a spur gear step preferably at a fixed gear of the main shaft. Among other things, this configuration creates construction space advantages.

It is intended to provide as many double wheel planes as gear ratios steps, to possibly minimize the dimensions of the invented double clutch transmission, in which the gear wheels of the counter shaft mesh with gear wheels of the transmission input shafts of the partial transmissions as well as with the gear wheels of the main shaft.

Due to the multi-use of idle gears of the gear ratios steps, the proposed double clutch transmission allows the realization of a maximum number of gear ratios with as few wheel planes as possible, whereby preferably the first eight forward gears are load shiftable in a sequential design.

In accordance with the invention, for optimization of the steps in the presented double clutch transmission, a dual wheel plane can be replaced, for instance, with two single wheel planes whereby a fixed gear is replaced with two fixed gears. Hereby, an especially harmonized and progressive gear stepping can be accomplished. It is also possible to substitute two single wheel planes with a dual wheel plane.

In an advantageous manner, the lower forward gears and the reverse gears can be activated, via a starting or shift clutch, respectively, hereby to concentrate larger loads to this clutch and, therefore, having the second clutch designed with a more advantageous construction space and lesser cost. In particular, both wheel planes can be positioned in the proposed double clutch transmission, so that starting can take place via the inner transmission input shaft, or also via the outer transmission input shaft, thus performing starting via a better suited clutch, which can also be achieved with a concentric positioned construction of the double clutch, radially nested within one another. Hereby, the wheel planes can be correspondingly mirror-symmetric positioned or exchanged, respectively.

### BRIEF DESCRIPTION OF THE DRAWINGS

Furthermore, the present invention is further explained based on the drawings. It shows:

FIG. 1 a schematic view of a first embodiment variation of an invented double clutch transmission;

FIG. 1A a possible shift scheme of the first embodiment variation of the double clutch transmission;

FIG. 1B a possible shift scheme in regarding the load shift ability of the first embodiment variation of the double clutch transmission;

FIG. 2 a schematic view of a second, possible embodiment variation of the invented double clutch transmission;

FIG. 2A a possible shift scheme of the second embodiment variation of the double clutch transmission;

FIG. 2B a possible shift scheme regarding the load shift ability of the second embodiment variation of the double clutch transmission;

FIG. 3 an additional schematic view of the second, possible embodiment variation of the invented double clutch transmission;

FIG. 4 a schematic view of a possible hybrid concept, as an example aced on the first embodiment variation of the double clutch transmission, and

FIG. 5 a schematic view of an additional design of the hybrid concept, as an example based on the first embodiment variation of the double clutch transmission.

### DETAILED DESCRIPTION OF THE PREFERRED EMBODIMENTS

As examples, the drawings show two possible embodiment variations of an invented double clutch transmission. The exemplary nine-gear or eight-gear double clutch transmission, respectively, preferably has two reverse gears R1 and R2 whereby, beside additional load shift gears, at least the first eight forward gears can be constructed as sequentially load shiftable, and also at least one of the forward gears can be realized as direct gear. However, the previously mentioned amount of gears are just an example, also different gear steps can be achieved.

The double clutch transmission comprises two clutches K1, K2, independent of the individual embodiment variations, where their input sides are connected with a drive shaft w0 and their output sides are each connected with one of the two transmission input shafts w1, w2 of the two partial transmissions which are positioned coaxially with respect to one another. The first transmission input shaft w1 is exemplary designed as solid shaft and the second transmission input shaft w2 is exemplary designed as a hollow shaft. To the first transmission input shaft w1 is, via a drive constant, a first counter shaft w6 assigned thereto, for instance as a hollow shaft, and to the second transmission input shaft 2, also via a drive constant, a second counter shaft w3 is assigned thereto, for instance as a solid shaft. The driveshaft w0 is coaxially positioned with an output shaft w5. The partial transmissions have, for instance, seven spur gear ratio steps assigned to them as wheel planes. Six of the assigned wheel planes are coupled, via the counter shafts w3, w6 and via the main shaft w4, as well as the planetary transmission which is designed as a range group with the output shaft w5. The seventh gear ratio step, which is designed as part of the second partial transmission, is independently coupled from the range group or the main shaft w4, directly with the output shaft w5, whereby the gear ratio step is directly linked with the planetary carrier PT of the planetary transmission which, by itself, is torque proof coupled with the output shaft w5.

Four dual-acting shift elements S1, S2, S3, S4, which are each represented in the drawings in their neutral position N, are provided for shifting of the gear ratio steps, whereby it is only indicated at the fourth shift element S4.

Two gear steps or gears, respectively, are in each case assigned to the transmission ratios steps, which realized through the range group. It is indicated in the drawings in a way that the gear steps, which are assigned to the transmission ratios steps, are listed above each other, whereby, in each case, the upper gear relates to the transmission ratio of the range group into a slow or low (L) and, in each case, the lower gear relates to the transmission ratio of the range group into fast or high (H).

Independent of the individual embodiment variation, the independent power path for the fifth gear is used. Because of the fact that the fifth gear, in regard to the gear ratio or number of teeth, respectively, of the involved gear wheels can be independently adjusted, also the first gear can be independently selected. This has the advantage that, although group transmissions have a necessary geometric stepping during a shift from the first into the second gear, a progressive stepping is possible. Since the gear ratios step for the reverse gears are shifted via the range group, two reverse gears R1 and R2 result in an advantage way.

Independent of the embodiment variations, the two transmission input shafts w1, w2, of the partial transmissions, each have a fixed gear z11, z21 assigned to them as a drive constant, which each mesh with an assigned fixed gear z12, z22 of the respective counter shaft w3, w6, so that, in total, seven wheel planes are provided as spur gears.

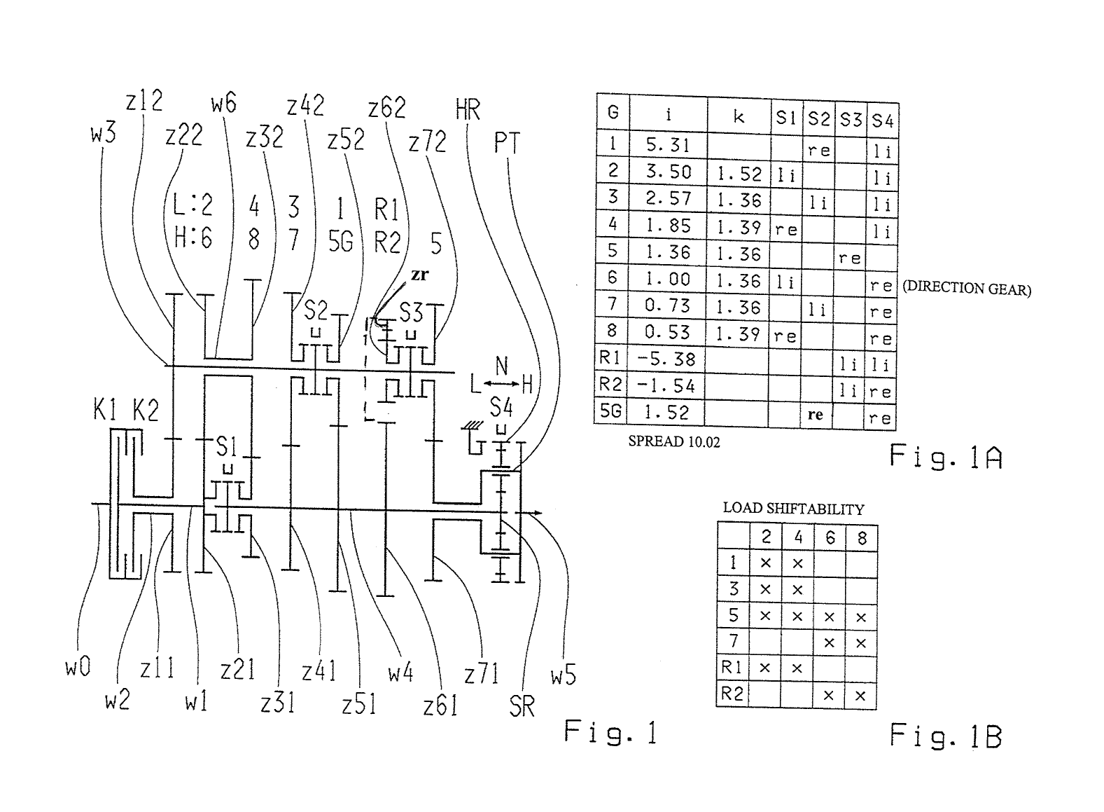

In a first embodiment variation of the double clutch transmission in accordance with FIGS. 1, 4, and 5, the counter shaft w6, which is connected with the transmission input shaft w1, has two fixed gears z22, z32 assigned thereto. The second counter shaft w3, which is connected with the second transmission input shaft w2, has a fixed gear z12 and four idle gears z42, z52, z62, z72 assigned thereto, whereby the two idle gears z42, z52, by means of the assigned second shift element S2 can be torque proof connected with the second counter shaft w3, depending on the shift direction. The two idle gears z62, z72 are connected by means of the assigned third shift element S3 with the second counter shaft w3, depending on the shift direction. In addition and in this embodiment variation, the main shaft w4 has three fixed gears z41, z51, z61 and two idle gears z31, z71 assigned thereto, whereby the idle gear z31 can be connected with the main shaft w4, via the first assigned shift element S1, and whereby the idle gear z71 is designed as non-shiftable. The idle gear, which is assigned to the main shaft w4, is directly connected with the planet carrier PT of the planetary transmission to connect the independent power path directly with the output shaft w5, because the fourth shift element S4, in this gear ratio, is in its neutral position N. The drive side end of the main shaft w4 can be connected, via the first dual functioning shift element S1, with the first transmission input shaft w1, whereby the output side end of the main shaft w4 is connected with the sun gear SR of the planetary transmission, which is designed as a range group. Depending on the shift direction of the fourth shift element S4, which is assigned to the ring gear HR of the planetary transmission, a gear ratio towards fast H or into slow L can be transferred to the output shaft w5.

In the first single-wheel plane as a drive constant, the fixed gear z11, of the second transmission input shaft w2, meshes with the fixed gear z12, of the second counter shaft w3. In the second single-wheel plane as a drive constant, the fixed gear z21, of the first transmission input shaft w1, meshes with the fixed gear z22, of the first counter shaft w6. In the third single-wheel plane, the idle gear z31, of the main shaft w4, meshes with the fixed gear z32, of the first counter shaft w6. In the fourth single-wheel plane, the fixed gear z41, of the main shaft w4, meshes with the idle gear z42, of the second counter shaft w3. In the fifth single-wheel plane, the fixed gear z51, of the main shaft w4, meshes with the idle gear z52, of the second counter shaft w3. In this sixth dual-wheel plane, the fixed gear z61, of the man shaft w4, meshes with an intermediate gear zr for rotation reversal for the reverse gear transmission ratios, whereby the intermediate gear zr also meshes with the idle gear z62, of the second counter shaft w3. In the seventh single-wheel plane, the idle gear z71, of the main shaft w4, meshes with the idle gear z72 of the second counter shaft w3, whereby the idle gear z71 is connected, via the planetary carrier PT, with the output shaft w5. The idle gear z71 can also be constructed as a short hollow shaft on the main shaft w4.

Thus, at least six single-wheel planes and one dual-wheel plane result in this example of the first embodiment variation, with a total of at least 15 gear wheels, as well as a planetary gear set as a range group, whereby the gear ratio steps are balanced and little forces occur at the teeth of the gear wheels. Also, small synchronizations occur in the first three shift elements S1, S2, S3 so that only one larger, dimensional synchronization is required for the fourth shift element S4.

The respective shift scheme, is presented in FIG. 1A, with exemplary gear ratios l and step increments k, as well as the spread, whereby the respective actuation direction of the shift elements S1, S2, S3, S4 is presented as li for left, and as re for right, in each case in reference to the actuation direction of the schematically presented shift elements in the drawing plane of the drawings.

Based on the shift scheme, in the example one can see that the first forward gear 1 is shifted via the second clutch K2 and via the second shift element S2, which connects the idle gear z52 with the second counter shaft w3, as well as via the fourth shift element S4, which connects the ring gear HR of the planetary transmission with the housing, whereby a second forward gear 2 is shifted via the first clutch K1 and via the first shift element S1, which connects the first transmission input shaft w1 with the main shaft w4, as well as via the fourth shift element S4, which connects the ring gear HR of the planetary transmission with the housing. The third forward gear 3 is shifted via the second clutch K2 and via the second shift element S2, which connects the idle gear z42 with the second counter shaft w3, as well as the fourth shift element S4, which connects the ring gear HR of the planetary transmission with the housing, whereby the fourth forward gear 4 is shifted via the first clutch K1 and the first shift element S1, which connects the idle gear z31 with the main shaft w4, as well as via the fourth shift element S4, which connects the ring gear HR of the planetary transmission with the housing. The fifth forward gear 5 is shifted via the second clutch K2 and via the third shift element S3, which connects the idle gear z72 with the second counter shaft w3, as well as the fourth shift element S4, which is assigned to the ring gear HR of the planetary transmission and which has the neutral position N, whereby the sixth forward gear 6 is shifted as a direct gear via the first clutch K1 and the first shift element S1, which connects the first transmission input shaft w1 with the main shaft w4, as well as via the fourth shift element S4, which connects the ring gear HR with the planetary carrier PT of the planetary transmission. The seventh forward gear 7 is shifted via the second clutch K2 and via the second shift element S2, which connects the idle gear z42 with the second counter shaft w3, as well as the fourth shift element S4, which connects the ring gear HR with the planetary carrier PT of the planetary transmission, whereby the eighth forward gear 8 is shifted via the first clutch K1 and via the first shift element S1, which connects the idle gear z31 with the main shaft w4, as well as via the fourth shift element S4, which connects the ring gear HR with the planetary carrier PT of the planetary transmission.

In addition, the reverse gear R1 is shifted via the second clutch K2 and via the third shift element S3, which connects the idle gear z62 with the second counter shaft w3, as well the fourth shift element, which connects the ring gear HR of the planetary transmission with the housing, whereby the additional reverse gear R2 is shifted via the second clutch K2 and the third shift element S3, which connects the idle gear z62 with the second counter shaft w3, as well as the fourth shift element S4, which connects the ring gear HR with the planetary carrier PT of the planetary transmission.

Furthermore, the additional forward gear 5G, as a range group gear, is shifted via the second clutch K2 and the second shift element S2, which connects the idle gear z52 with the second counter shaft w3, as well as the fourth shift element S4, which connects the ring gear HR with the planetary carrier PT of the planetary transmission.

In the first embodiment variation in accordance with FIGS. 1, 3, 4, the second wheel plane has the gears 2 and 6 assigned thereto, the third wheel plane the gears 4 and 8, the fourth wheel plane the gears 3 and 7, the fifth wheel plane the gears 1 and 5G, the sixth wheel plane the reverse gears R1 and R2, as well as the seventh wheel plane has the fifth gear 5 assigned thereto. The planetary transmission, as the range group, is assigned to the end at the output side of the main shaft w4 as well as to the output shaft w5, where the sun gear SR is connected with the main shaft w4 and the planetary carrier PT is connected with the output shaft w5. The ring gear HR has the fourth shift element assigned thereto in a way, to shift the transmission ratio ranges, so that the ring gear HR in a first shift position, which is directed to the left in the drawing plane, is connected with the housing, and, in a second shift position, which is directed to the right in the drawing plane, is connected with the planetary carrier PT. The fourth shift element S4 can, beside the neutral position N, therefore, realize a shift to the right into the gear ratio range fast H and during the shift to the left into slow L. In the exemplary design of the wheel set, the gear ratio range into the fast H means that the sun gear SR rotates at the same rotation speed as the planet carrier PT, whereby the gear ratio range into the slow L represents a reduction ratio.

In accordance with FIG. 1B, an example for a shift scheme of the first embodiment variation is shown in regard to the load shift ability of the gears of the double clutch transmission. In this shift scheme, the gear shifts or gear changes, respectively, which are marked with X can be used as load shiftable.

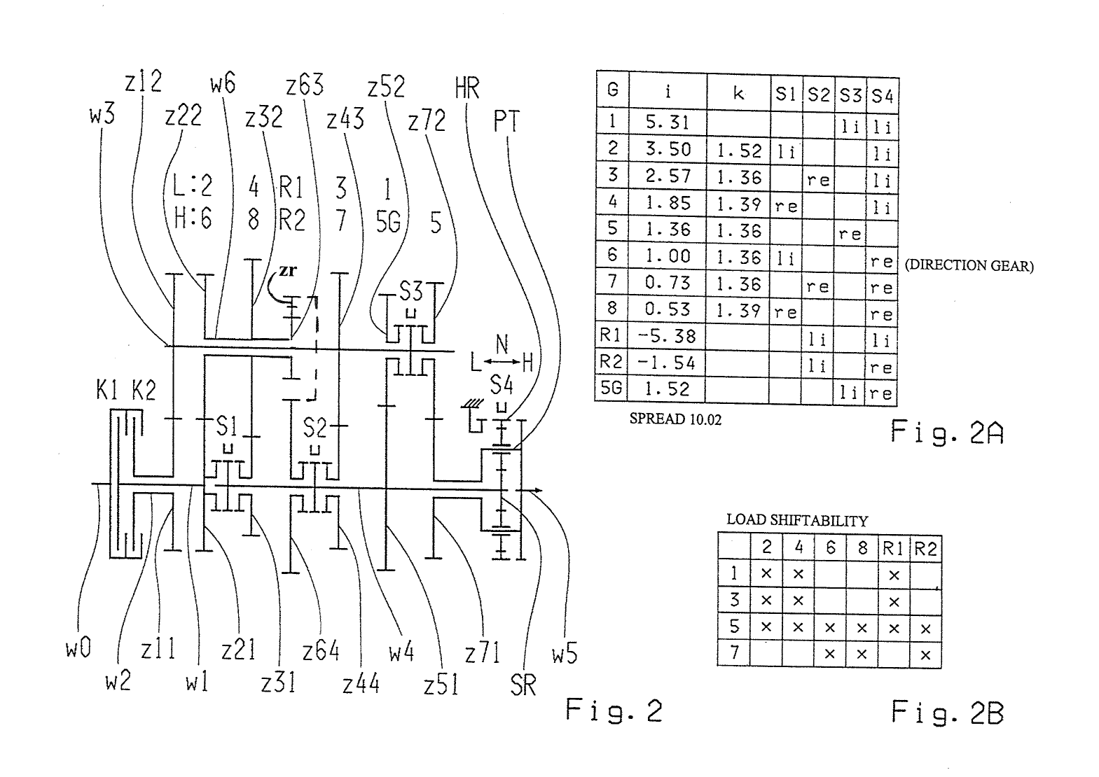

In accordance with a second embodiment variation of the double clutch transmission in FIG. 2, the counter shaft w6, which is connected with the first transmission input shaft w1, has three fixed gears z22, z32, z63 assigned thereto. The counter shaft w3, connected with the second transmission input shaft w2, has two fixed gears z12, z43 and two idle gears z52, z72 assigned thereto, whereby the idle gears z52, z72 can be connected with the second counter shaft w3 via the third assigned shift element S3, depending on the shift direction. In addition, in the second embodiment variation, the main shaft w4 has a fixed gear z51 and four idle gears z31, z64, z44, z71 assigned thereto, whereby the idle gear z31 can be connected with the main shaft w4 via the assigned first shift element S1, whereby the two idle gears z64, z44 can be connected with the main shaft w4 via the assigned second shift element S2, depending on the shift direction, and whereby the idle gear z71 is designed as non-shiftable. The idle gear z71 is directly connected with the planetary carrier PT of the planetary transmission to connect the independent power path directly with the output shaft w5, since the fourth shift element S4 is in its neutral position N during this gear ratio. The drive side end of the main shaft w4 can be connected with the first transmission input shaft w1 via the first dual-functioning shift element S1, whereby the output side end of the main shaft w4 is connected with the sun gear SR of the planetary transmission, which is designed as a range group. Depending on the shift direction of the shift element S4, which is assigned to the ring gear HR of the planetary transmission, a gear ratio into fast H or into slow L can be transferred to the output shaft w5.

In the presented wheel set of FIG. 2, in the first single-wheel plane as a drive constant, the idle gear z11 of the second transmission input shaft w2 meshes with the fixed gear z12 of the second counter shaft w3, whereby in the second single-wheel plane as a drive constant, and the idle gear z21 of the second transmission input shaft w2 meshes with the fixed gear z22 of the first counter shaft w6. In the third single-wheel plane, the idle gear z31 of the main shaft w4 meshes with the fixed gear z32 of the first counter shaft w6. In the fourth dual-wheel plane, the idle gear z64 of the main shaft w4 meshes with an intermediate gear zr for rotation reversal of the reverse gear ratios, whereby the intermediate gear zr also meshes with the fixed gear z63 of the first counter shaft w6. In the fifth single-wheel plane, the idle gear z44 of the main shaft w4 meshes with the fixed gear z43 of the second counter shaft w3. In the sixth single-wheel plane, the fixed gear z51 of the main shaft w4 meshes with the idle gear z52 of the second counter shaft w3. In the seventh single-wheel plane, the idle gear z71 of the main shaft w4 meshes with the idle gear z72 of the second counter shaft w3, whereby the idle gear z71 is connected, via the planetary carrier PT, with the output shaft w5. The idle gear z71 can also be designed as a short hollow shaft on the main shaft w4.

Thus, in accordance with FIG. 2, this example of the second embodiment variation shows six single-wheel planes and one dual-wheel plane with a total of 15 gear wheels as well as a planetary set, which is designed as a range group.

The related shift scheme is shown as an example in FIG. 2A with gear ratios l and step increments k, as well as a spread, whereby the actuating direction of the shift elements S1, S2, S3, S4 is marked as li for left and with re four right, in each case in reference to the direction of movement of the schematically shown shift elements in the drawing plane of the drawings.

As an example in shift scheme, it can be seen that the first forward gear 1 is shifted via the second clutch K2 and via the third shift element S3, which connects via the idle gear z52 with the second counter shaft w3, as well as via the fourth shift element S4, which connects the planetary transmission with the housing via the ring gear HR, whereby the second forward gear 2 is shifted via the first clutch K1 and via the first shift element S1, which connects the first transmission input shaft w1 and the main shaft w4, as well as the fourth shift element S4, which connects the ring gear HR of the planetary transmission with the housing. The third forward gear 3 is shifted via the second clutch K2 and the second shift element S2, which connects the idle gear z44 with the main shaft w4, as well as the fourth shift element S4, which connects the ring gear HR of the planetary transmission with the housing, whereby the fourth forward gear 4 is shifted via the first clutch K1 and the first shift element S1, which connects the idle gear z31 with the main shaft w4, as well as the fourth shift element S4, which connects the ring gear HR of the planetary transmission with the housing. The fifth forward gear 5 is shifted via the second clutch K2 and via the third shift element S3, which connects via the idle gear z72 with the second counter shaft w3, as well as the fourth shift element S4, which is assigned to the ring gear HR of the planetary transmission and provided in its neutral position N, whereby the sixth forward gear 6 is shifted via the first clutch K1 and the first shift element S1, which connects the first transmission input shaft w1 with the main shaft w4, as well as the at the fourth shift element S4, which connects the ring gear HR with the planet carrier PT of the planetary transmission, as a direct gear. The seventh forward gear 7 is shifted via the second clutch K2 and the second shift element S2, which connects the idle gear z44 with the main shaft w4, as well as the fourth shift element S4, which connects the ring gear HR with the planetary carrier PT of the planetary transmission, whereby the eighth forward gear 8 is shifted via the first clutch K1 and the first shift element S1, which connects the idle gear z31 with the main shaft w4, as well as the fourth shift element S4, which connects the ring gear HR with the planetary carrier PT of the planetary transmission.

In addition, the reverse gear R1 is shifted via the first clutch K1 and the second shift element S2, which connects the idle gear z64 with the main shaft w4, as well as the fourth shift element S4, which connects the ring gear HR of the planetary transmission with the housing, whereby the additional reverse gear R2 is shifted via the first clutch K1 and the second shift element S2, which connects the idle gear z64 with the main shaft w4, as well as the fourth shift element S4, which connects the ring gear HR with the planetary carrier PT of the planetary transmission.

Also, the additional forward gear 5G, as a range group gear, is shifted via the second clutch K2 and the third shift element S3, which connects the idle gear z52 with the second counter shaft w3, as well as the fourth shift element S4, which connects the ring gear HR with the planetary carrier PT of the planetary transmission.

Thus, in the second embodiment variation according to FIG. 2, the second wheel plane has the gears 2 and 6 assigned thereto, the third wheel plane has the gears 4 and 8, the fourth wheel plane has the reverse gears R1 and R2 assigned thereto, the fifth wheel plane the gears 3 and 7, the sixth wheel plane the gears 1 and 5G, and the seventh wheel plane has the gear 5 assigned thereto. The planetary transmission, as a range group, is designed to the output side end of the main shaft w4, as well as to the output shaft w5, in which the sun gear SR is connected with the main shaft w4 and the planetary carrier PT with the output shaft w5. To shift the transmission ratio ranges, the ring gear HR as the fourth shift element S4 is assigned thereto in a way so that the ring gear HR in a first shift position, which is directed to the left in the drawings plane, is connected with the housing, and, in a second shift position, which is directed to the right in the drawings plane, is connected with the planetary carrier PT. The fourth shift element S4, beside the neutral position N, can therefore shifted to the right into the transmission ratio range fast H, and shifted to the left into slow L. In this exemplary design of the wheel set, the transmission ratio range into fast H means that the sun gear SR rotates at the same rotation speed as the planetary carrier PT, whereby the transmission ratio range into slow L means a reduction ratio.

In accordance with FIG. 2, a shift scheme is exemplary presented for the second embodiment variation regarding the load shift ability of the gears of the double clutch transmission. In this shift scheme, the gear shifts or gear changes, respectively, which are marked with X can be used as load shiftable.

The second embodiment variation, in accordance with FIG. 2, distinguishes itself by the fact that the reverse gear transmission ratios R1, R2 are assigned to the first partial transmission. It results in the advantage that shifts from the first gear 1, which is assigned to the second partial transmission into the reverse gears R1, R2, or vice versa, can be executed as load shiftable.

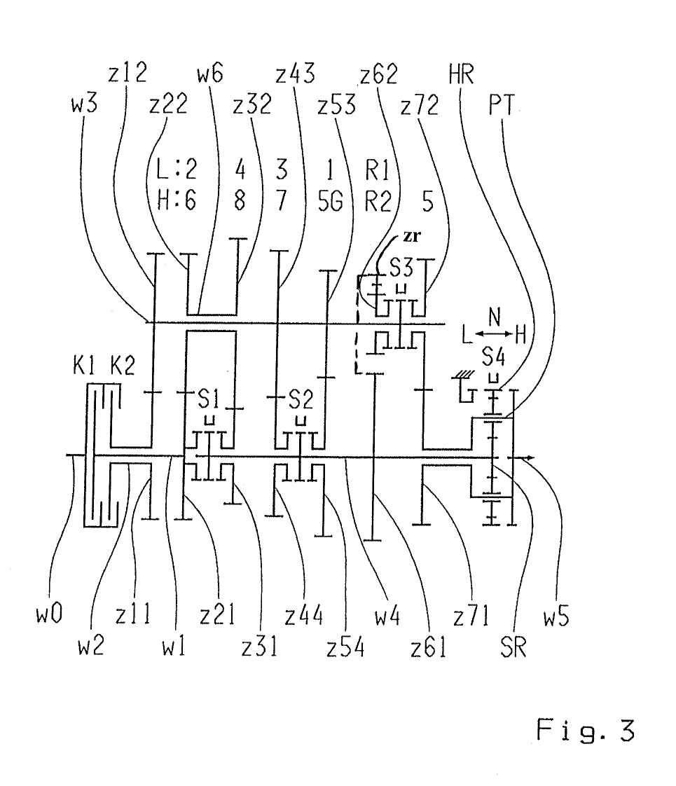

FIG. 3 shows mainly a gear wheel concept in accordance with the second embodiment variation, in accordance with FIG. 2, however, the reverse gear transmission ratios, assigned to the second partial transmission or the second counter shaft w3, respectively, are different from FIG. 2.

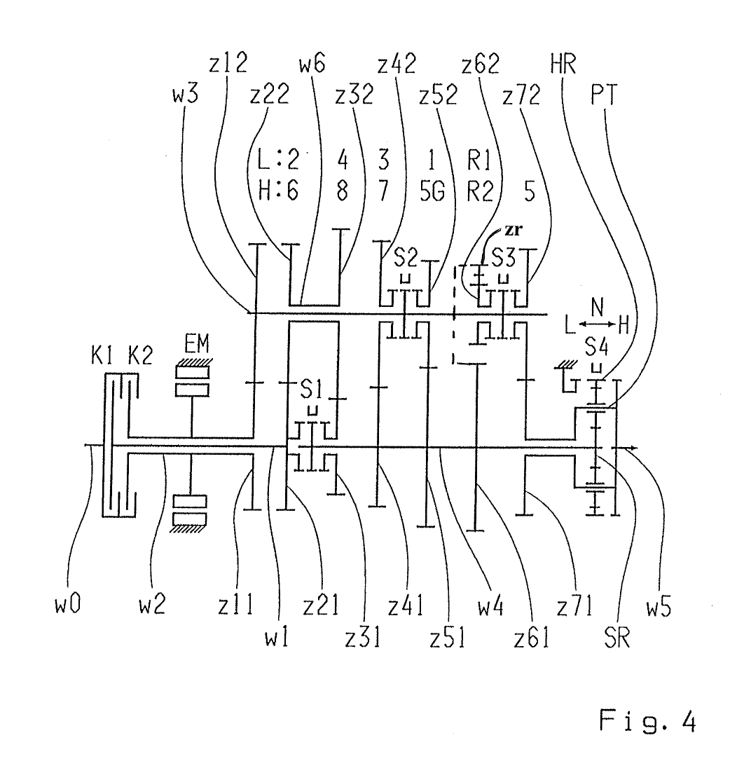

Based on the first embodiment variation, a hybrid concept is exemplary presented in FIG. 4 in which the electro machine EM is linked to the second partial transmission by directly connecting the electro machine EM with the second transmission input shaft w2. Therefore, during an electric drive, via the range group, a possibility arises to utilize the gear ratio steps of the first, the third, the fifth, and the seventh gears, as well as the reverse gear transmission ratios. Starting of the combustion engine, in the neutral position, can for instance take place with a 1:1 transmission ratio, via the second transmission input shaft w2, if the second clutch K2 is engaged.

A special advantage arises by a method where starting of the combustion engine can take place, via the first partial transmission, due to the de-coupling possibility of the output shaft via the neutral shift of the range group. Hereby, the lowest gear 1 of the second partial transmission and the largest gear 8 of the first partial transmission can be used, for instance, if during a disengaged second clutch K2, the idle gear z52 is connected with the second counter shaft w3, via the second shift element S2, and therefore also with the second transmission input shaft w2, and when also the idle gear z31 is connected with the main shaft w4, via the first shift element S1, and therefore also with the first transmission input shaft w1, and when the first clutch K1 is engaged and when also the range group or fourth shift element S4, respectively, is in the or its neutral position N, as it is presented for instance in FIG. 4. Thus, the result is an advantageous transmission ratio during starting between the electric machine EM and the combustion engine. For starting of the combustion engine via the first partial transmission, gear ratio steps other than the previously mentioned can also be utilized.

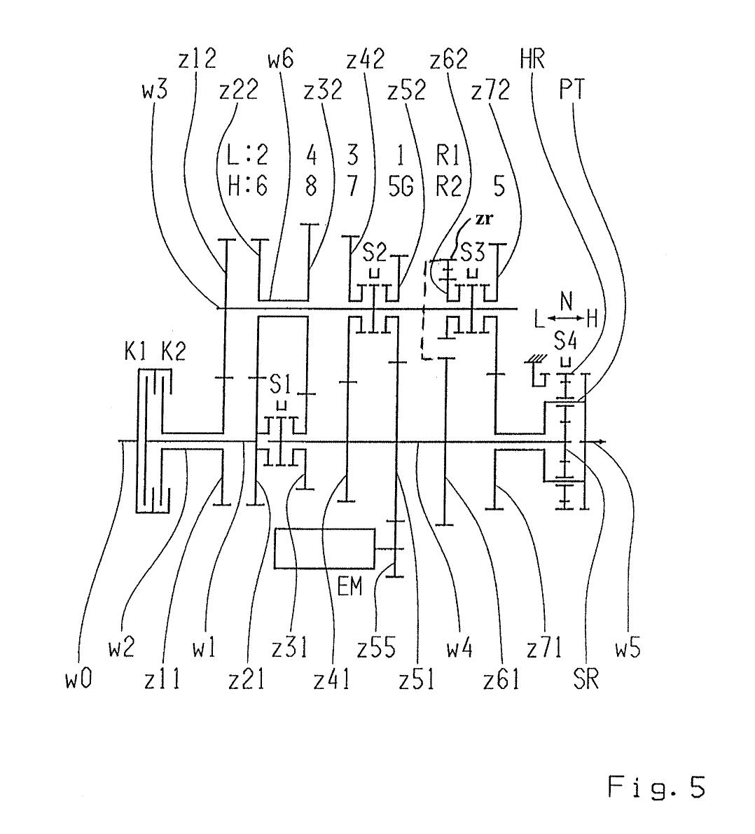

FIG. 5 shows an additional hybrid concept, as an example, based on the first embodiment variation. The electric machine EM, for instance in this concept, is coupled via a spur gear step, through the fixed gear or drive pinion z55, respectively, of the electric machine EM and the fixed gear z51 coupled with the main shaft w4. Thus, via the spur gear step the electric machine EM is attached sideways or axial parallel, respectively, to the counter shaft w3. Hereby, also the gears two and six, among others, can be used for an electric drive. In addition, during starting of the combustion engine in neutral, the largest possible transmission ratio can be used which is, in this case, the eighth gear, which can be realized, when the first clutch K1 is engaged, through the connection of the idle gear z31 via the assigned first shift element S1.

The advantage arises that the double clutch does not rotate during a pure electric drive, so that no dragging losses occur when driving via the partial transmission. In addition, the electric machine EM can replace a large synchronization, for instance at the fourth shift element, which is assigned to the ring gear HR of the planetary transmission.

It is also possible that the attachment of the electric machine EM can be realized via an additional constant transmission ratio or also via an additional shift element for the coupling or decoupling, respectively.

However, the presented hybrid concepts, which are only shown with the first embodiment variation, can also be used with the second embodiment variation in accordance with FIGS. 2 and 3.

### REFERENCE CHARACTERS

1 First Forward Gear
2 Second Forward Gear
3 Third Forward Gear
4 Fourth Forward Gear
5 Fifth Forward Gear
5G Fifth Forward Gear as Range Group Gear
6 Sixth Forward Gear
7 Seventh Forward Gear
8 Eights Forward Gear
R1 Reverse Gear
R2 Reverse Gear
w0 Drive Shaft
w1 First transmission input shaft input shaft of the first partial transmission
w2 Second transmission input shaft of the second partial transmission
w6 First countershaft
w3 Second countershaft
w4 Main Shaft
w5 Output Shaft
K1 First Clutch
K2 Second Clutch
z11 Fixed Gear of the second transmission input shaft
z21 Fixed Gear of the first transmission input shaft
z22 Fixed Gear of the first countershaft
z32 Fixed Gear of the first countershaft
z63 Fixed Gear of the first countershaft
z12 Fixed Gear of the second countershaft
z43 Fixed Gear of the second countershaft
z53 Fixed Gear of the second countershaft
z42 Idle Gear of the second countershaft
z52 Idle Gear of the second countershaft
z6 Idle Gear of the second countershaft
z72 Idle Gear of the second countershaft
z31 Idle Gear of the Main Shaft
z71 Non-shiftable Idle Gear of the Main Shaft
z64 Idle Gear of the Main Shaft
z44 Idle Gear of the Main Shaft
z54 Idle Gear of the Main Shaft
z41 Fixed gear of the Main Shaft
z51 Fixed gear of the Main Shaft
z61 Fixed gear of the Main Shaft
z55 Fixed Gear of Drive Pinion, respectively, of the EM
SR Sun Gear of the planetary transmission or the Range Group, respectively
HR Ring Gear of the Planetary Transmission or the Range Group, respectively
PT Planetary Carrier of the Planetary Transmission or the Range Group, respectively
zr Intermediate Gear for rotational reversal for the reverse gear ratio
EM Electric Machine
H high section of the Range Group
L low section of the Range Group
N Neutral Position of the Range Group or the Shift Element, respectively
S1 First double-functioning Shift Element
S2 Second double-functioning Shift Element
S3 Third double-functioning Shift Element
S4 Fourth double-functioning Shift Element

1-20. (canceled)

21. A double clutch transmission comprising:
first and second clutches (K1, K2) each having an input section connected with a drive shaft (w0) and a respective output section connected with a first or a second transmission input shaft (w1, w2) of the first and second partial transmissions, the first and the second transmission input shafts (w1, w2) are positioned coaxially with respect to one another, and positioned coaxial with respect to first and second counter shafts (w3, w6),
each of the first and the second partial transmissions having several shiftable transmission ratios steps assigned thereto, each of the several shiftable transmission ratios steps being couplable with a main shaft (w4) and being couplable, via an input section of a planetary transmission designed as a range group, with the output shaft (w5),
the output shaft (w5) being coaxial positioned with the driveshaft (w0), and
at least a shiftable gear ratio step, of at least one of the partial transmissions, can be coupled with the output shaft (w5) independent of the range group.

22. The double clutch transmission according to claim 21, wherein four dual-functioning shift elements (S1, S2, S3, S4) are provided for a sequential load shiftable shifting of at least for a first eight forward gears.

23. The double clutch transmission according to claim 21, wherein the shiftable gear ratio step of the first partial transmission is directly connected with the output shaft (w5), independent of the range group, via the planetary carrier (PT) of the planetary transmission, and a fourth shift element (S4), which is shifted into a neutral position (N), is assigned to a ring gear (HR).

24. The double clutch transmission according to claim 23, wherein the additional transmission ratios steps are coupled, via at least one of the counter shafts (w3, w6) and the main shaft (w4), with the sun gear (SR) of the planetary transmission and, dependent on the shift position of the fourth shift element (S4) which is assigned to the ring gear (HR), a range transmission ratio into either a fast range (H) or into a slow range (L) occurs.

25. The double clutch transmission according to claim 21, wherein the first and the second transmission input shafts (w1, w2) of the partial transmissions have each a fixed gear (z11, z21) assigned thereto as a drive constant, and each fixed gear (z11, z21) meshes with an assigned fixed gear (z12, z22) of the respective counter shaft (w3, w6) so that a total of seven gear planes are provided as spur gear steps.

26. The double clutch transmission according to claim 21, wherein the first counter shaft (w6), which is coupled to the first transmission input shaft (w1), has two fixed gears (z22, z32) assigned thereto,
the second counter shaft (w3), which is coupled to the second transmission input shaft (w2), has a fixed gear (z12) and four idle gears (z42, z52, z62, z72) assigned thereto, a second dual-functioning shift element (S2) facilitates shifting of a first two of the four idle gears (z42, z52) and a third dual functioning shift element facilitates shifting of a second two of the four idle gears (z62, z 72),
the main shaft (w4) has three fixed gears (z41, z51, z61) and two idle gears (z31, z71) assigned thereto, and a first one of the two idle gears (z31) is shiftable by the first dual-functioning shift element (S1) and a second one of the two idle gears (z71) is not shiftable, and
the drive side end of the main shaft (w4) is connectable, via the first dual-functioning shift element (S1), with the first transmission input shaft (w1), and an output side end of the main shaft (w4) is connected with the sun gear (SR) of the planetary transmission, which is designed as range group.

27. The double clutch transmission according to claim 21, wherein, in a first gear plane, a fixed gear (z11) of the second transmission input shaft (w2) meshes with a fixed gear (z12) of the second counter shaft (w3),
in a second gear plane, a fixed gear (z21) of the first transmission input shaft (w1) meshes with a first fixed gear (z22) of the first counter shaft (w6),
in a third gear plane, a first idle gear (z31) of the main shaft (w4) meshes with a second fixed gear (z32) of the first counter shaft (w6),
in a fourth gear plane, a first fixed gear (z41) of the main shaft (w4) meshes with a first idle gear (z42) of the second counter shaft (w3),
in a fifth gear plane, a second fixed gear (z51) of the main shaft (w4) meshes with the second idle gear (z52) of the second counter shaft (w3),
in the sixth gear plane, a third fixed gear (z61) of the main shaft (w4) meshes with an intermediate gear (zr), for rotational speed reversal for the reverse gear transmission ratios, and the intermediate gear (zr) meshes with a third idle gear (z62) of the second counter shaft (w3), and
in a seventh gear plane, a second idle gear (z71) of the main shaft (w4) meshes with a fourth idle gear (z72) of the second counter shaft (w3), and the fourth idle gear (z71) is connected, via the planetary carrier (PT) of the planetary transmission, with the output shaft (w5).

28. The double clutch transmission according to claim 27, wherein a first forward gear (1) is shiftable via the second clutch (K2), a second shift element (S2) which connects the second idle gear (z52) with the second counter shaft (w3), and a fourth shift element (S4) which connects the ring gear (HR), of the planetary transmission with the housing,
a second forward gear (2) is shiftable via the first clutch (K1), a first shift element (S1) which connects the first transmission input shaft (w1) with the main shaft (w4) and the fourth shift element (S4) which connects the ring gear (HR), of the planetary transmission, with the housing,
a third forward gear (3) is shiftable via the second clutch (K2), the second shift element (S2) which connects the first idle gear (z42) with the second counter shaft (w3), and the fourth shift element (S4) which connects the ring gear (HR), of the planetary transmission, with the housing,
a fourth forward gear (4) is shiftable via the first clutch (K1), the first shift element (S1) which connects the first idle gear (z31) with the main shaft (w4), and the fourth shift element (S4) which connects the ring gear (HR), of the planetary transmission, with the housing,
a fifth forward gear (5) is shiftable via the second clutch (K2), a third shift element (S3) which connects the fourth idle gear (z72) with the second counter shaft (w3), and the fourth shift element (S4) which is designed as the ring gear (HR), of the planetary transmission, and located in a neutral position (N),
a sixth forward gear (6) is shiftable, as a direct gear, via the first clutch (K1) and the first shift element (S1) which connects the first transmission input shaft (w1) with the main shaft (w4), and the fourth shift element (S4) which connects the ring gear (HR) with the planetary carrier (PT) of the planetary transmission,
a seventh forward gear (7) is shiftable via the second clutch (K2), the second shift element (S2) which connects the first idle gear (z42) with the second counter shaft (w3), and the fourth shift element (S4) which connects the ring gear (HR) with the planetary carrier (PT) of the planetary transmission, and
an eighth gear (8) is shiftable via the first clutch (K1), the first shift element (S1) which connects the first idle gear (z31) with the main shaft (w4), as well as the fourth shift element (S4) which connects the ring gear (HR) with the planetary carrier (PT) of the planetary transmission.

29. The double clutch transmission according to claim 27, wherein the reverse gear (R1) is shiftable via the second clutch (K2) and the third shift element (S3) which connects the third idle gear (z62) with the second counter shaft (w3), and the fourth shift element (S4) which connects the ring gear (HR) of the planetary transmission with the housing, and
an additional reverse gear (R2) is shiftable via the second clutch (K2), the third shift element (S3) which connects the third idle gear (z62) with the second counter shaft (w3), and the fourth shift element (S4) which connects the ring gear (HR) with the planetary carrier (PT) of the planetary transmission.

30. The double clutch transmission according to claim 28, wherein an additional forward gear (5G), as a range group gear, is shiftable via the second clutch (K2), the second shift element (S2) which connects the idle gear (z52) with the second counter shaft (w3), and the fourth shift element (S4) which connects the ring gear (HR) with the planetary carrier (PT) of the planetary transmission.

31. The double clutch transmission according to claim 21, wherein the first counter shaft (w6), which is connected with the first transmission input shaft (w1), has three fixed gears (z22, z32, z63) assigned thereto, the second counter shaft (w3) which is connected with the second transmission input shaft (w2) has a first and second fixed gears (z12, z43) and first and second idle gears (z52, z72) assigned thereto, the first and second idle gears (z52, z72) are each shiftable by a third dual-functioning shift element (S3), and the main shaft (w4) has a fixed gear (z51) and first, second, third and fourth idle gears (z31, z64, z44, z71) assigned thereto, the first idle gear (z31) is shiftable via a first dual-functioning shift element (S1), and the second and third idle gears (z64, z44) are each shiftable via a second dual-functioning shift element (S2), and the fourth idle gear (z71) is not shifted, and a drive side end of the main shaft (w4) is connectable, via the first dual-functioning shift element (S1), with the first transmission input shaft (w1) and an output side end of the main shaft (w4) is connected with the sun gear (SR) of the planetary transmission, which is designed as a range group.

32. The double clutch transmission according to claim 31, wherein in a first gear plane, the fixed gear (z11) of the second transmission input shaft (w2) meshes with the first fixed gear (z12) of the second counter shaft (w3),
in a second gear plane, the fixed gear (z21) of the first transmission input shaft (w1) meshes with a second fixed gear (z22) of the first counter shaft (w6),
in a third gear plane, the first idle gear (z31) of the main shaft (w4) meshes with a second fixed gear (z32) of the first counter shaft (w6),
in a fourth gear plane, the second idle gear (z64) of the main shaft (w4) meshes with an intermediate gear (zr), for rotational speed reversal for reverse gear transmission ratios, and the intermediate gear (zr) also meshes with the fixed gear (z63) of the first counter shaft (w6),
in a fifth gear plane, the second fixed gear (z43) of the second counter shaft (w3) meshes with the third idle gear (z44) of the main shaft (w4),
in a sixth gear plane, the fixed gear (z51) of the main shaft (w4) meshes with the first idle gear (z52) of the second counter shaft (w3), and
in a seventh gear plane, the fourth idle gear (z71) of the main shaft (w4) meshes with the second idle gear (z72) of the second counter shaft (w3), and the fourth idle gear (z71) is connected with the output shaft (w5), via the planetary carrier (PT) of the planetary transmission.

33. The double clutch transmission according to claim 31, wherein a first forward gear (1) is shiftable via the second clutch (K2), the third shift element (S3) which connects the first idle gear (z52) with the second counter shaft (w3), and the fourth shift element (S4) which connects the ring gear (HR) of the planetary transmission with the housing,
a second forward gear (2) is shiftable via the first clutch (K1), the first shift element (S1) which connects the first transmission input shaft (w1) with the main shaft (w4), and the fourth shift element (S4) which connects the ring gear (HR) of the planetary transmission with the housing,
a third forward gear (3) is shiftable via the second clutch (K2), the second shift element (S2) which connects the third idle gear (z44) with the main shaft (w4), and the fourth shift element (S4) which connects the ring gear (HR) of the planetary transmission with the housing,
a fourth forward gear (4) is shiftable via the first clutch (K1), the first shift element (S1) which connects the first idle gear (z31) with the main shaft (w4), and the fourth shift element (S4) which connects the ring gear (HR) of the planetary transmission with the housing,
a fifth forward gear (5) is shiftable via the second clutch (K2), the third shift element (S3) which connects the second idle gear (z72) with the second counter shaft (w3), and the fourth shift element (S4) which is assigned to the ring gear (HR) of the planetary transmission and located in a neutral position (N),
a sixth forward gear (6) is shiftable directly via the first clutch (K1), the first shift element (S1) which connects the first transmission input shaft (w1) with the main shaft (w4), and the shift element (S4) which connects the ring gear (HR) with the planetary carrier (PT) of the planetary transmission,
a seventh forward gear (7) is shiftable via the second clutch (K2), the second shift element (S2) which connects the third idle gear (z44) with the main shaft (w4), and the fourth shift element (S4) which connects the ring gear (HR) with the planetary carrier (PT) of the planetary transmission, and
an eighth gear (8) is shiftable via the first clutch (K1), the first shift element (S1) which connects the first idle gear (z31) with the main shaft (w4), and the fourth shift element (S4) which connects the ring gear (HR) with the planetary carrier (PT) of the planetary transmission.

34. The double clutch transmission according to claim 31, wherein a reverse gear (R1) is shiftable via the first clutch (K1), the second shift element (S2) which connects the second idle gear (z64) with the main shaft (w4), and the fourth shift element (S4) which connects the ring gear (HR) of the planetary transmission with the housing, and
an additional reverse gear (R2) is shiftable via the first clutch (K1), the second shift element (S2) which connects the second idle gear (z64) with the main shaft (w4), as well as via the fourth shift element (S4) which connects the ring gear (HR) with the planetary carrier (PT) of the planetary transmission.

35. The double clutch transmission according to claim 31, wherein an additional forward gear (5G), as a range group, is shiftable via the second clutch (K2), the third shift element (S3) which connects the first idle gear (z52) with the second counter shaft (w3), and the fourth shift element (S4) which connects the ring gear (HR) with the planetary carrier (PT) of the planetary transmission.

36. The double clutch transmission according to claim 21, wherein the main shaft (w4) is coaxial positioned with reference to both the driveshaft (w0) and the output shaft (w5).

37. The double clutch transmission according to claim 21, wherein the first counter shaft (w6), assigned to the first transmission input shaft (w1), is designed as a hollow shaft and the second counter shaft (w3), assigned to the second transmission input shaft (w2), is designed as a solid shaft.

38. The double clutch transmission according to claim 21, wherein at least one an electric machine (EM) is one of directly and indirectly coupled with the main shaft (w4).

39. The double clutch transmission according to claim 21, wherein that at least one electric machine (EM) is directly or indirectly coupled with the second transmission input shaft (w2).

40. The double clutch transmission according to claim 21, wherein at least nine forward gears (1, 2, 3, 4, 5, 5G, 6, 7, 8) and at least two reverse gears (R1, R2) are shiftable and at least one of the forward gears (6, 8) is designed as a direct gear.
